(19) United States
(12) Patent Application Publication
(10) Pub. No.: US 2005/0026620 A1
(43) Pub. Date: Feb. 3, 2005

(54) Bridge station for mobile phone

(76) Inventor: Edgar Aramis Holguin, Alhambra, CA (US)

Correspondence Address: Raymond Y. Chan, Suite 128, 108 N. Ynez Ave., Monterey Park, CA, 91754, US

(21) Appl. No.: 10/629,236

(22) Filed: Jul. 28, 2003

(51) Int. Cl. H04Q 7/20

(52) U.S. Cl. 455/445

(57) ABSTRACT

A bridge station, which is adapted for bridging between at least a domestic phone and a mobile phone, includes a mobile phone bridging arrangement for communicatively connecting with the signal outlet of the mobile phone and a call control system for communicatively connecting with the domestic phone. The call control system includes a central processing unit electrically connected to the mobile phone bridging arrangement for communication signal transaction between the call control system and the mobile phone bridging arrangement, and a call diverting unit electrically connected to the central processing unit for diverting an incoming call from the mobile phone to the domestic phone and for diverting an outgoing call from the domestic phone to the mobile phone.

### BACKGROUND OF THE PRESENT INVENTION

1. Field of Invention

The present invention relates to a mobile phone, and more particularly to a bridge station for a mobile phone, which is adapted to direct mobile phone signal to a domestic phone so that a user is able to utilize his/her domestic phone as the mobile phone without needing to pay domestic phone's bill.

2. Description of Related Arts

Mobile phones are widely utilized all over the world for they provide a convenient yet generally affordable means of instantaneous communication, even at international level. Generally speaking, most people choose to switch on their mobile phones during daytime so that they can communicate to others whenever necessary, provided that they are in a place where their mobile network subscription covers. During nighttime, when most people go back home from work or from schools, they generally choose to switch off their mobile phones in order to save the ‘talking time’ which they have subscribed usually at a contractual price.

It should be noted that however, such usual practices are subject to several inherent and sometimes subtle disadvantages. First relates to inefficient use of resources. Very often, people pay for their mobile communication network at a fixed price, and the network provider entitles the individual user to enjoy a predetermined amount of talking time. As a usual business practice, many network providers tend to set their mobile network charge in such a manner that the more talking time they subscribe, the cheaper the talking time price per minute. As a result, many people respond to the incentive by choosing to a network subscription package which includes a longer predetermined talking time. Of course, it is perfectly unproblematic for a user to respond to such incentive. After all, it is one of the basic principles in economics that people usually respond to incentives. Problem arises when people substantially overestimate their required talking time due to the influence of the incentive. Hence, very often, people will find that every time they pay their mobile network bill, there is substantial unused talking time. However, as they have agreed to pay for at least a predetermined talking time, they are unable to make any refund for those used talking time. Even worse, when people subscribe a particular mobile network service, they have concluded a legally enforceable contract which states that the user must subscribe the particular network for a certain period of time. As such, as all expected, they respond to the incentive by generating substantial wastage of money (in the form of a mobile network payment).

The above disadvantage is further deteriorated by a usual practice that people tend to divert their mobile phone calls to domestic phone line when they go back home. Originally, the underlying reason for so doing is that people could save more expensive mobile phone payment by diverting mobile phone calls to cheaper domestic phone line whenever feasible, such as at home. However, as a derivative problem of the above-mentioned disadvantage, because people unable to use up all their mobile network talking time in the first place, further diverting mobile phone calls to domestic phone line would impose unnecessary usage of the domestic phone line, leading to additional charging by the corresponding domestic phone line provider.

In addition, while moving, the user must deactivate the old phone service from the previous place and re-activate another new phone service for a new location. Likewise, the user must get different phone services for home, mobile phone, and office respectively. In other words, the user cannot switch the phone services between office and home.

A more subtle disadvantage which is associated with the above-mentioned disadvantages is that people usually pay extra when at home in the sense that at the time they are at home, they pay both mobile network service fee and domestic phone line service fee, even though for most people, their domestic phones have been already wireless. Then, repetition of payment for substantially the same payment is imposed on most people who subscribe both domestic phone line service and mobile network service. Furthermore, when they require additional communication tools such as a fax machine, they usually have to establish another phone line which is exclusive for facsimile transmissions.

With the above discrepancies at hands, a novel and unobvious invention is thus required for reconciling or restructuring the existing mobile phone service and domestic phone service.

### SUMMARY OF THE PRESENT INVENTION

A main object of the present invention is to provide a bridge station for mobile phone which is adapted to be connected between an active mobile phone and a regular domestic phone in such a manner that mobile phone calls are arranged to be diverted to the domestic phone without utilizing domestic phone network service. In other words, the domestic phone service is substituted by mobile phone service.

Another object of the present invention is to provide a bridge station for mobile phone which enables a user to make the most efficient use of the mobile phone network subscribed so as to minimize economical wastage in associated with phone networks payment, both for mobile network and for domestic phone network.

Another object of the present invention is to provide a bridge station for mobile phone which is compatible with popular communication accessories which utilize domestic phone line as a channel for signal transmission.

Another object of the present invention is to provide a bridge station for mobile phone, wherein the use of the bridge station is adapted to substitute the office phone network service such that the home phone service, the office phone service, and the mobile phone service can be simply combined in one single phone line through the bridge station of the present invention.

Another object of the present invention is to provide a bridge station for mobile phone which does not involve complicated network connection and sophisticated electronic components so as to minimize the manufacturing cost yet maximize the competitive edge of the present invention.

Another object of the present invention is to provide a bridge station for mobile phone which does not alter the original design and structure of either domestic phone or the mobile phone so that the present invention is capable of being compatible with most domestic and mobile phones.

Another object of the present invention is to provide a bridge station which acts as an accessory for mobile phones, such as being utilized as a mobile phone charger, so as to provide optimal complementary service to the user of the present invention.

Accordingly, in order to accomplish the above objects, the present invention provides a bridge station for bridging between at least a domestic phone and a mobile phone having a signal outlet, comprising:
a mobile phone bridging arrangement comprising a signal input adapted for connecting with the signal outlet of the mobile phone so as to communicate with the mobile phone; and
a call control system, which is adapted for communicatively connecting with the domestic phone, comprising a central processing unit electrically connected to the mobile phone bridging arrangement for communication signal transaction between the call control system and the mobile phone bridging arrangement, and a call diverting unit electrically connected to the central processing unit for diverting an incoming call from the mobile phone to the domestic phone and for diverting an outgoing call from the domestic phone to the mobile phone.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a bridge station for mobile phone according to a preferred embodiment of the present invention.

FIG. 2 is a schematic diagram of the operation of a conventional mobile phone.

FIG. 3 is a block diagram of the bridge station according to the above preferred embodiment of the present invention.

FIG. 4 is a flow chart of the operation of incoming and outgoing calls for the bridge station according to the above preferred embodiment of the present invention.

FIG. 5 illustrates an alternative mode of the bridge station for mobile phone according to the above preferred embodiment of the present invention.

### DETAILED DESCRIPTION OF THE PREFERRED EMBODIMENT

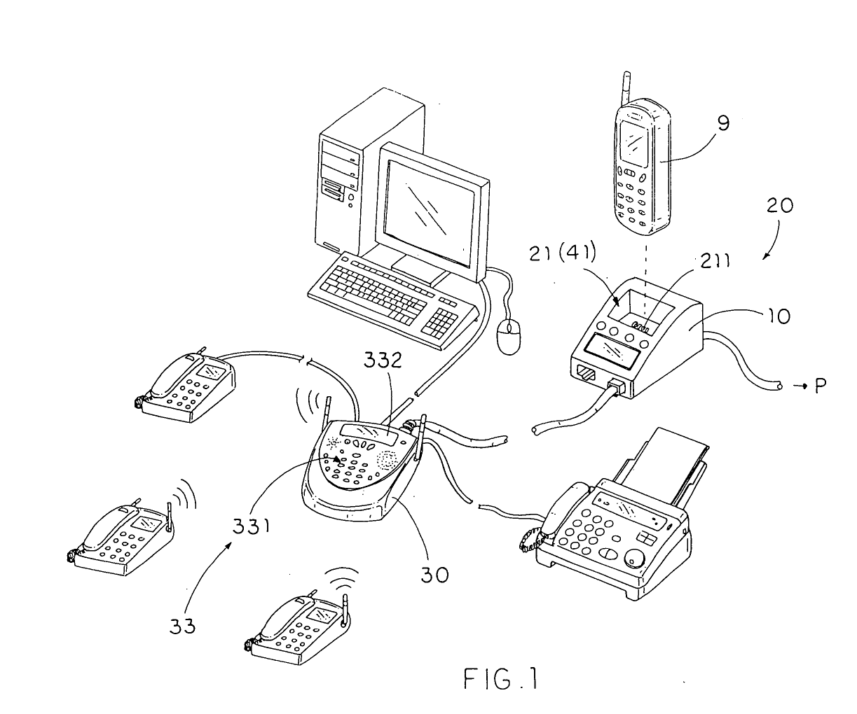

Referring to FIGS. 1, 3 and 4 of the drawings, a bridge station for bridging between a mobile phone 9 and a domestic phone according to a preferred embodiment of the present invention is illustrated, wherein the domestic phone can be embodied as a regular home phone service or an office phone service.

According to the preferred embodiment, the bridge station comprises a mobile phone bridging arrangement 20 adapted for communicatively connecting with the mobile phone 9 and a call control system 30 adapted to be connected with a fixed line telephone, such as a regular domestic telephone, so that phone calls directed to the mobile phone 9 are capable of being diverted to the fixed line telephone through the call control system 30.

Referring to FIG. 1 of the drawings, the mobile phone bridging arrangement 20 comprises a signal input 21 adapted for connecting with a signal outlet of the mobile phone 9 so as to communicate with the mobile phone 9.

The mobile phone bridging arrangement 20 is received in an outer case 10 wherein the signal input 21 is embodied as a mobile phone disposing slot formed on the outer case 10. A plurality of electrodes 211 are disposed in the mobile phone disposing slot of the signal input 21 to electrically connect with the signal output of the mobile phone 9 wherein electrical pulses, including those of digital form (such as audio signal) and analogue form (such as electrical power) are capable of being transferred to and from the call control system 30 through the electrodes 211.

According to the preferred embodiment, the mobile phone bridging arrangement 20 further comprises a signal transmitting device 22 adapted to send and receive a communication signal, wherein the signal transmitting device 22 is adapted for receiving a calling signal as the communication signal from the mobile phone 9 while receiving the incoming call therefrom and for sending a dialing signal as the communication signal from the domestic phone while calling out the outgoing call therefrom.

The signal input 21 of the mobile phone bridging arrangement 20 is shaped and sized in such a manner that a resting portion, such as a back and a bottom portion, of a predetermined kind of mobile phone 9 is adapted to fittedly engage and securely rest on the outer case 10 at its normal operative condition. In other words, when the signal outlet of the mobile phone 9 is fittedly engaged with the signal input 21, the electrodes 211 are adapted to electrically connect with the respective electrical terminals of the mobile phone 9 so that electrical pulses are capable of being transferred to the bridge station 9 through the electrodes 211.

A trivial alternative of the mobile phone bridging arrangement 20 which should be covered by the present invention is that the mobile phone bridging arrangement 20 may comprises a plurality of communication slots provided on the mobile phone 9 and the outer case 10 respectively, and a communicating cable having two electric plugs formed at two ends thereof and adapted to plug into the respective communication slot in such a manner that communication signals (electrical signals) communicated between the mobile phone 9 and the bridge station are transferred through the communicating cable.

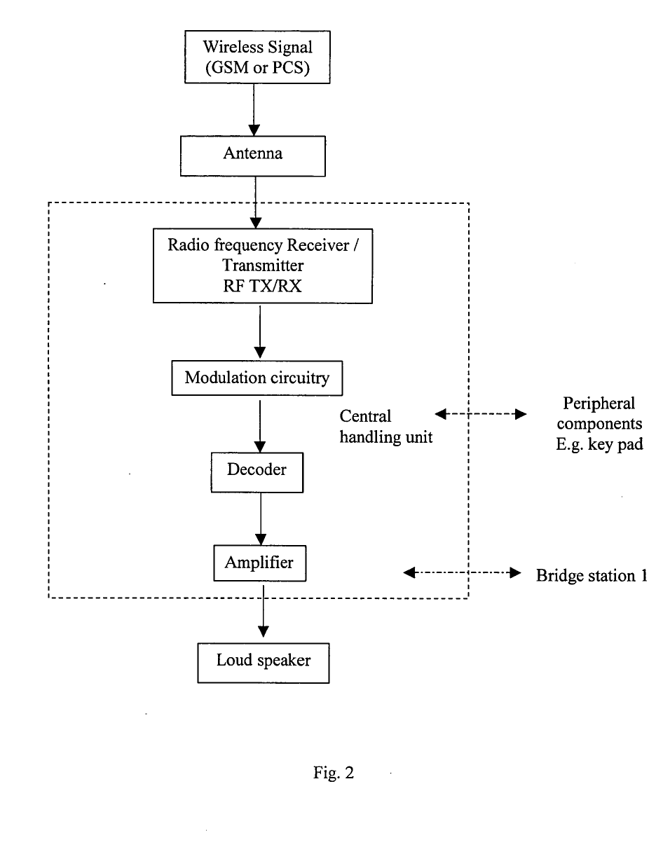

As shown in FIG. 2, the mobile phone 9 is preferably a regular mobile phone having the capabilities of receiving wireless signal from a particular mobile telecommunication provider at a range of discrete frequencies, such as 1900 MHz for a particular Global System (or Standard) for Mobile (GSM) telecommunication network in the United States of America. For a regular mobile phone, the wireless signal is usually received through an antenna and processed by a central handling unit which is operatively or electrically connected to a variety of peripheral components such as a keypad, a switch button, and/or a display unit typically provided on a casing of the mobile phone 9.

The central handling unit of the mobile phone 9 usually comprises a radio frequency transmit/receive (RF TX/RX) circuitry, and a modulation circuitry. The radio frequency transmit/receive circuitry is electrically connected with the antenna wherein wireless signal, such as Frequency Modulation (FM) signal, received by the antenna is filtered and mixed into a lower frequency signal which is then fed into the modulation circuitry. The lower frequency signal is then demodulated by the modulation circuitry into a stream of continuous signal, decoded by a decoder, amplified and then fed into a loud speaker of the mobile phone 9.

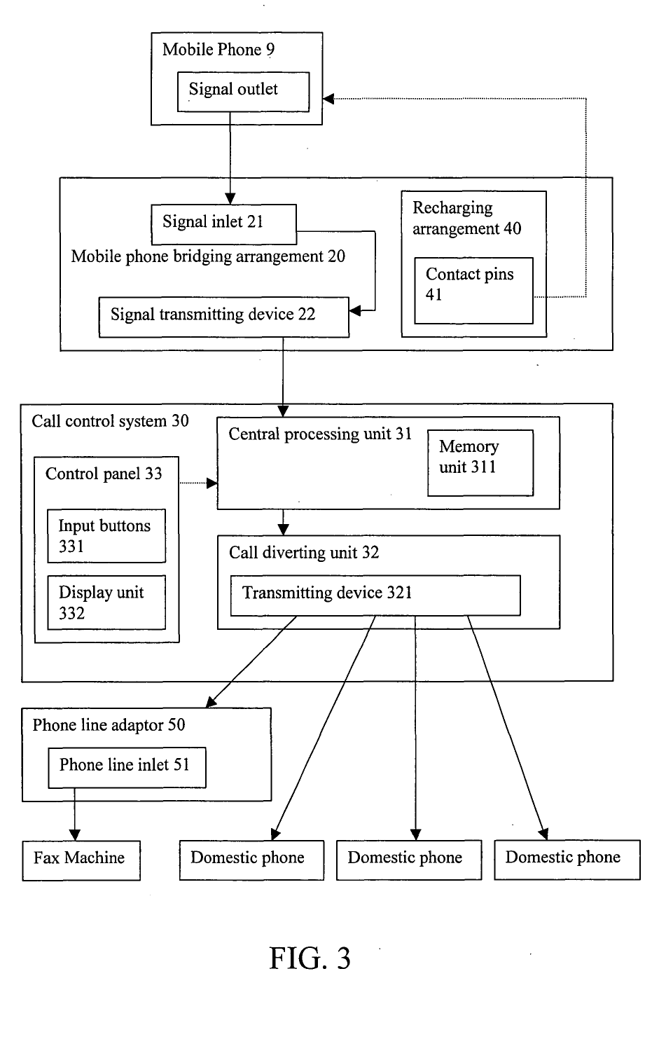

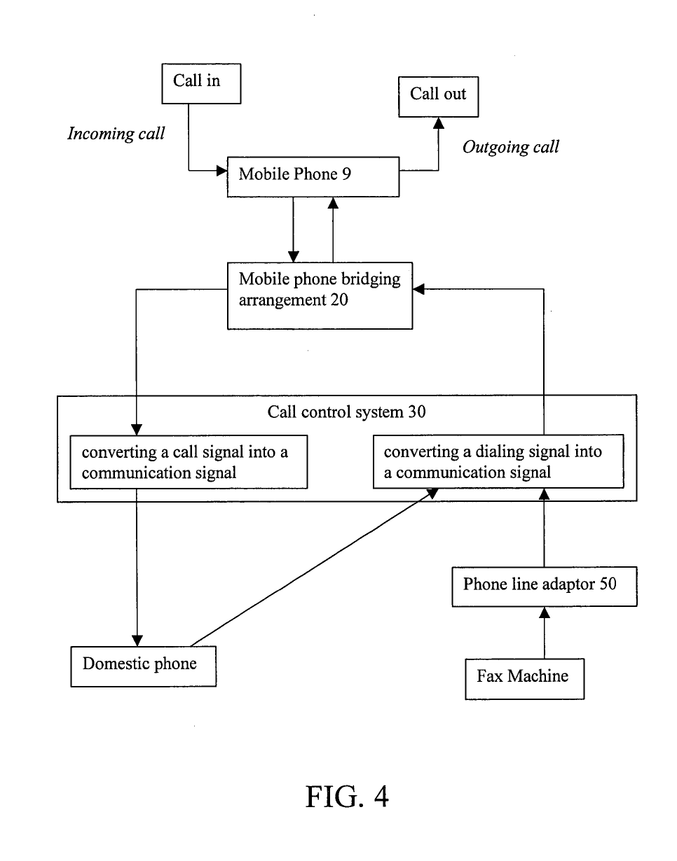

Referring to FIGS. 3 and 4 of the drawings, the call control system 30, which is adapted for communicatively connecting with the domestic phone, comprises a central processing unit 31 electrically connected to the mobile phone bridging arrangement 20 for communicating data transaction between the call control system 30 and the mobile phone bridging arrangement 20, and a call diverting unit 32 electrically connected to the central processing unit 31 for diverting an incoming call from the mobile phone 9 to the domestic phone and for diverting an outgoing call from the domestic phone to the mobile phone 9.

The central processing unit 31 is electrically connected with the electrodes 211 in such a manner that the communication signals from the mobile phone 9 is capable of being delivered to and from the central processing unit 31 through the electrodes 211. According to the preferred embodiment, the central processing unit 31 may be electrically connected with a memory unit 311, such as a predetermined capacity of Random Access Memory (RAM), which is capable of storing a plurality of phone numbers which are to be diverted and a plurality of user's commands such as differing call forwarding parameters, and/or commanding programs governing the operation of the bridge station of the present invention.

The communication signals received from the mobile phone 9 is processed in the central processing unit 31 in accordance with a predetermined computer program which is pre-installed and stored in the memory unit 311 of the central processing unit 31. According to the preferred embodiment, upon corresponding settings in the mobile phone 9 by the user of the present invention, the low frequency signal in the mobile phone 9, having demodulated and decoded as mentioned above, is arranged to feed into the call control system 30 through the electrodes 211 of the mobile phone bridging arrangement 20 wherein the central processing unit 31 is electrically informed that a mobile phone call is detected by the mobile phone 9, preferably through a re-encoder.

The central processing unit 31, which is a processing circuit, is primarily utilized to process the communication signal from the mobile phone 9, and once the central processing unit 31 is informed that an incoming call is detected, an appropriate call divert command, such as an incoming call signal for a conventional domestic phone, is made in accordance with the pre-installed program stored in the central processing unit 31. Thus, as an illusory example, the pre-installed program could be a plurality of commands leading to retrieval of content of a particular address in the memory unit 311, wherein that particular address may be stored with a predetermined phone number to which the user of the present invention prefers that the incoming mobile call is to be directed.

Accordingly, more than one mobile phone 9 can be communicatively connected to the mobile phone bridging arrangement 20 so as to direct the incoming call from the mobile phone 9 to the corresponding domestic phone. In other words, when at least two mobile phones 9 are connected to the mobile phone bridging arrangement 20, the central processing unit 31 will detect the communication signal from the corresponding mobile phone 9 in such a manner that the call diverting unit 32 is arranged to direct the incoming call from the mobile phone 9 to the corresponding domestic phone.

The call diverting unit 32 is electrically connected with the central processing unit 31 and is adapted to transform digital signal coming from the central processing unit 31 to an ultimate phone signal which is recognizable to a conventional domestic phone. In other words, the bridge station of the present invention is adapted to be electrically connected to a conventional phone through a regular phone wire wherein the ultimate phone signal is fed into the conventional phone for call diverting. It is worth to mention that conventionally, a domestic phone is connected to a fixed phone line which is provided by local phone company so that phone calls directing to that domestic phone is transmitted to it through the phone line which is originated from the phone company. As a result, the conventional phone is adapted to be connected with the bridge station of present invention so that incoming calls directing towards the mobile phone 9 is capable of being diverted to the conventional domestic phone without it being connected to a fixed phone line.

Accordingly, for the outgoing call, the call diverting unit 32 comprises a transmitting device 321 for transmitting the dialing signal from the domestic phone to the central processing unit 31, wherein the central processing unit 31 is arranged to convert the dialing signal to a digital form for transmitting to the mobile phone 9.

Hence, the call control system 30 further comprises a control panel 33 provided on the outer case 10 wherein the control panel 33 is preferably embodied as comprising a plurality of input buttons 331 and a display unit 332 both electrically connected with the central processing unit 31 so that user's commands are capable of being inputted to the central processing unit 31 by means of operating the control panel 33. Furthermore, the operation of the central processing unit 31 can be communicated to the user of the present invention in a real time basis through the information displayed in the display unit 332. The display unit 332 is preferably a Liquid Crystal Display (LCD) provided on the outer case 10 for clearly displaying whatever information which is relevant to the operation of the present invention.

Accordingly, the control panel 33 is a parameter inputting device that allows being input a preset parameter for matching the mobile phone 9 to the corresponding domestic phone through the call control system 30. In other words, the control panel 33 is arranged to match each of the mobile phones 9 to the corresponding domestic phone. As it is mentioned above, when two or more mobile phones 9 are connected to the mobile phone bridging arrangement 20, the user is able to preset the incoming call from the first mobile phone 9 directing to the first domestic phone and the incoming call from the second mobile phone 9 directing to the second domestic phone through the control panel 33.

As shown in FIG. 1, the mobile phone bridging arrangement 20 and the call control system 30 are embodied as a computerized device, such as a computer, to form a single programmable bridging circuit. Alternatively, the call control system 30 can be a computer that the domestic phone is connected thereto wherein the mobile phone bridging arrangement 20 is externally connected to the call control system 30.

The operation the bridge station is briefed as follows:
(1) Communicatively connect the mobile phone bridging arrangement 20 and the call control system 30 to the mobile phone 9 and the domestic phone respectively so as to communicate the mobile phone 9 with the domestic phone through the bridge station.
(2) Divert the incoming call from the mobile phone 9 to the domestic phone by:
(2.1) processing the communication signal from the mobile phone 9 to the central processing unit 31 of the call control system 30.
(3) Divert the outgoing call from the domestic call to the mobile phone 9 through the call diverting unit 32 of the call control system 30.
(3.1) processing the dialing signal from the domestic phone to the mobile phone 9 and the central processing unit 31 of the call control system 30.

When the mobile phone 9 receives the incoming call, the communication signal is sent from the mobile phone 9 in step (1) wherein the communication signal in digital form is processed through the central processing unit 31 and is converted into a domestic phone recognizable form in step (2.1). Then, the call diverting unit 32 is arranged to divert the incoming call to the desired domestic phone in step (2).

For outgoing call, the dialing signal from the domestic phone is diverted to the central processing unit 31 to convert into the digital signal in step (3.1). Then, the mobile phone will send out the call in step (3).

In other words, prior to actual call diverting, a user of the present invention is required to input at least one phone number which is to be diverted to the central processing unit 31 by means of the control panel 33. After that, the user is required to plug the signal outlet of the mobile phone 9 in the signal inlet of the mobile phone bridging arrangement 20 so that the communication signal from the mobile phone 9 is capable of being transmitted to the bridge station through the plurality of electrodes 211 as mentioned above. When the incoming call is detected by the mobile phone 9, the communication signal is arranged to be transmitted to the bridge station and then processed in the central processing unit 31 in the manner described previously. The incoming call is then diverted to the domestic phone which is adapted to substitute the mobile phone in surrounding circumstances where the physical body of the mobile phone 9 is unnecessary or undesirable, yet the wireless telecommunication network is nevertheless desire to be continuously utilized, not by the mobile phone 9, but by the conventional domestic phone.

In order to further enhance the compatibility of the present invention, the bridge station further comprises a recharging arrangement 40 for the purpose of charging the mobile phone 9. Referring to FIG. 4 of the drawings, the recharging arrangement 40 comprises a plurality of contact pins 41 built-in with the mobile phone bridging arrangement 20 at a position of the signal inlet 21 and adjacent to the electrodes 211 so that when the mobile phone 9 is fittedly disposed in the signal inlet 21, the contact pins 41 are arranged to be electrically communicated with two recharging inlets of the mobile phone 9 wherein electrical signals recharging the battery of the mobile phone 9 is transmitted from the bridge station to the mobile phone 9 through the contact pins 41.

Alternatively, the contact pins 41 may be embodied as being extended outwardly from the bridge station through electrical wires wherein the contact pins are adapted to be plugged into a recharging inlet of the mobile phone 9 so that electrical signal recharging the battery in the mobile phone 9 is transmitted from the bridge station to the mobile phone 9 through the contact pins 41 and the recharging inlet.

The recharging arrangement 40 further comprises a charging circuitry electrically connected with the central processing unit 31 and the contact pins 41, wherein the charging circuitry is adapted to deliver electrical charging signal to the mobile phone 9 when the charging inlet is in electrical contact with the contact pins 41, subject to the governance of various charging parameters, such as potential difference, pre-stored in the central processing unit 31. Accordingly, a detecting sub-circuitry may be implemented to the charging circuitry for detecting the presence of the mobile phone 9 in the signal inlet 21.

It is worth mentioning that it is possible for the contact pins 41 to be embodied as the electrodes 211 so that the contact pins 41 and the electrodes 211 are integrally connected together respectively for transmitting electrical signal to and from the mobile phone 9.

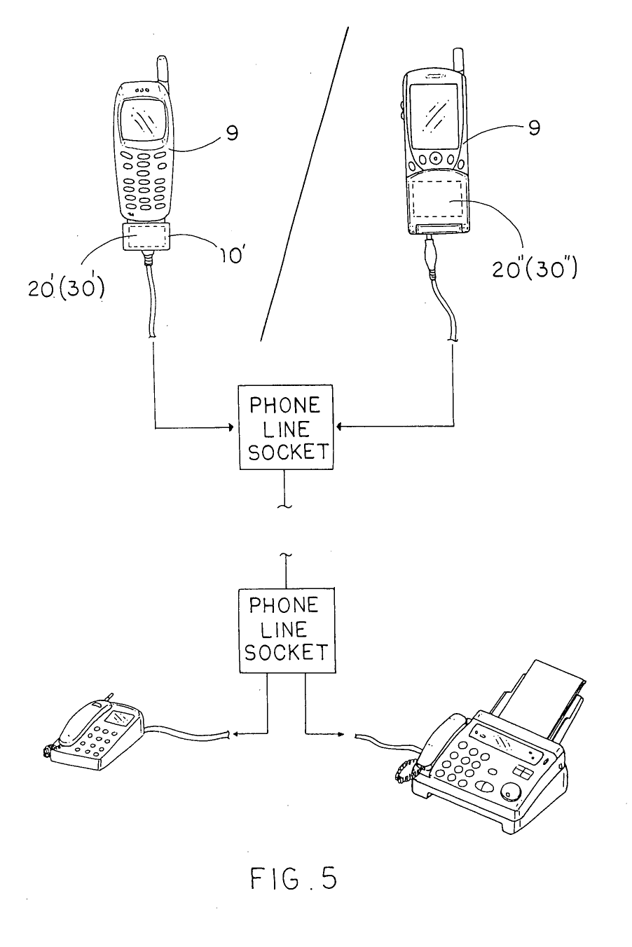

FIG. 5 illustrates an alternative mode of the bridge station which comprises a mobile phone bridging arrangement 20′ and a call control system 30′ built-in with the mobile phone bridging arrangement 20′ to form a bridging circuit wherein the mobile phone bridging arrangement 20′ and the call control system 30′ are received in the outer case 10′ to externally connect to the mobile phone 9. Accordingly, the bridge station is arranged to directly plug into a phone line socket so as to communicatively connect with the domestic phone. It is worth to mention that at home or office, the connection between the domestic phones is already interconnected through an internal phone system having the phone line sockets provided at the wall so that the user is able to plug the domestic phone to the phone line socket to network with the domestic phone. Therefore, by using the existing internal phone system, the bridge station is adapted to communicatively connect with domestic phone through the phone line socket.

It is worth to mention that the mobile phone bridging arrangement 20″ and a call control system 30″ are adapted to built-in with the mobile phone 9 wherein the mobile phone 9 is capable of directly plugging to the phone line socket. Accordingly, the mobile phone bridging arrangement 20″ and a call control system 30″ are built-in with the circuit of the mobile phone 9 as one of the functions thereof, such that the user is able to switch the mobile phone 9 in a bridging mode to communicatively connect with the domestic phone through the phone line socket, as shown in FIG. 5.

One skilled in the art would appreciate that the bridge station of the present invention provides call diverting for mobile phone 9 so that user no longer need to ‘repeat’ paying telecommunication fee—i.e. fixed line and mobile telecommunication fee. Instead, depending on the particular circumstances of each individual, users may choose to stop subscribing fixed line telecommunication network yet they are able to continuously utilize their regular domestic phone at home or office, using mobile telecommunication network. In other words, the user is able to directly switch the phone between home and office via the mobile phone through the bridge station of the present invention by utilizing one single mobile phone service.

For those having specific purposes for subscribing fixed line telecommunication network, the bridge station of the present invention may further comprises a phone line adaptor 50 comprising at least a phone line inlet 51 provided on the call control system 30 wherein a wide variety of communication devices, such as a fax machine, is adapted to connect with the bridge station through the phone line inlet 51. Furthermore, the phone line inlet 51 is adapted to be extended to a fixed phone line so that, for example, the fax machine is capable of connecting to a fixed phone line through the bridge station. In other words, the present invention is capable of facilitating mobile phone forwarding solely by utilizing mobile telecommunication network, and, at the same time, fixed phone line telecommunication network for a variety of communication apparatuses.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

1. A bridge station for bridging between at least a domestic phone and at least a mobile phone, comprising:
a mobile phone bridging arrangement for connecting with said mobile phone so as to communicate with said mobile phone; and
a call control system, which is adapted for communicatively connecting with said domestic phone, comprising a central processing unit electrically connected to said mobile phone bridging arrangement for communication signal transaction between said call control system and said mobile phone bridging arrangement, and a call diverting unit electrically connected to said central processing unit for diverting an incoming call from said mobile phone to said domestic phone and for diverting an outgoing call from said domestic phone to said mobile phone.

2. The bridge station, as recited in claim 1, wherein said mobile phone bridging arrangement further comprises a signal transmitting device adapted to send and receive said communication signal, wherein said signal transmitting device is adapted for receiving a calling signal as said communication signal from said mobile phone while receiving said incoming call therefrom and for sending a dialing signal as said communication signal from said domestic phone while calling out said outgoing call therefrom.

3. The bridge station, as recited in claim 2, wherein said the call diverting unit comprises a transmitting device for transmitting said dialing signal from said domestic phone to said central processing unit, wherein said central processing unit is arranged to convert said dialing signal to a digital form for transmitting to said mobile phone.

4. The bridge station, as recited in claim 1, further comprising a recharging arrangement built-in with said mobile phone bridging arrangement for recharging said mobile phone when said mobile phone is electrically connected to said mobile phone bridging arrangement.

5. The bridge station, as recited in claim 2, further comprising a recharging arrangement built-in with said mobile phone bridging arrangement for recharging said mobile phone when said mobile phone is electrically connected to said mobile phone bridging arrangement.

6. The bridge station, as recited in claim 3, further comprising a recharging arrangement built-in with said mobile phone bridging arrangement for recharging said mobile phone when said mobile phone is electrically connected to said mobile phone bridging arrangement.

7. The bridge station, as recited in claim 1, further comprising a control panel electrically connected to said central processing unit, wherein said control panel is a parameter inputting device that allows to be input a preset parameter for matching said mobile phones to said corresponding domestic phone through said call control system.

8. The bridge station, as recited in claim 3, further comprising a control panel electrically connected to said central processing unit, wherein said control panel is a parameter inputting device that allows to be input a preset parameter for matching said mobile phones to said corresponding domestic phone through said call control system.

9. The bridge station, as recited in claim 6, further comprising a control panel electrically connected to said central processing unit, wherein said control panel is a parameter inputting device that allows to be input a preset parameter for matching said mobile phones to said corresponding domestic phone through said call control system.

10. The bridge station, as recited in claim 1, wherein said mobile bridging arrangement are built-in with said call control system to form a bridging circuit for externally connecting said mobile phone with said domestic phone through a phone line socket.

11. The bridge station, as recited in claim 3, wherein said mobile bridging arrangement are built-in with said call control system to form a bridging circuit for externally connecting said mobile phone with said domestic phone through a phone line socket.

12. The bridge station, as recited in claim 6, wherein said mobile bridging arrangement are built-in with said call control system to form a bridging circuit for externally connecting said mobile phone with said domestic phone through a phone line socket.

13. The bridge station, as recited in claim 9, wherein said mobile bridging arrangement are built-in with said call control system to form a bridging circuit for externally connecting said mobile phone with said domestic phone through a phone line socket.

14. The bridge station, as recited in claim 1, wherein said mobile bridging arrangement are built-in with said call control system to form a bridging circuit for building in with said mobile phone to connect with said domestic phone through a phone line socket.

15. The bridge station, as recited in claim 3, wherein said mobile bridging arrangement are built-in with said call control system to form a bridging circuit for building in with said mobile phone to connect with said domestic phone through a phone line socket.

16. The bridge station, as recited in claim 6, wherein said mobile bridging arrangement are built-in with said call control system to form a bridging circuit for building in with said mobile phone to connect with said domestic phone through a phone line socket.

17. The bridge station, as recited in claim 9, wherein said mobile bridging arrangement are built-in with said call control system to form a bridging circuit for building in with said mobile phone to connect with said domestic phone through a phone line socket.

18. A process of bridging between a mobile phone and a domestic phone through a bridge station which comprises a mobile phone bridging arrangement and a call control system electrically connected thereto, comprising the steps of:
(a) communicatively connecting said mobile phone bridging arrangement and said call control system to said mobile phone and said domestic phone respectively so as to communicate said mobile phone with said domestic phone through said bridge station;
(b) diverting an incoming call from said mobile phone to said domestic phone; and
(c) diverting an outgoing call from said domestic phone to said mobile phone.

19. The process, as recited in claim 18, wherein said call control system comprises a central processing unit electrically connected to said mobile phone bridging arrangement for communication signal transaction between said call control system and said mobile phone bridging arrangement, a call diverting unit electrically connected to said central processing unit for diverting an incoming call from said mobile phone to said domestic phone and for diverting an outgoing call from said domestic phone to said mobile phone.

20. The process as recited in claim 19, in step (b), further comprising the steps of:
(b-1) converting a call signal of said incoming call from said mobile phone into said communication signal through said central processing unit; and
(b-2) sending said communication signal to said domestic phone through said call diverting unit.

21. The process as recited in claim 19, in step (c), further comprising the steps of:
(c-1) converting a dialing signal of said outgoing call from said domestic phone into said communication signal through said central processing unit; and
(c-2) sending said communication signal to said mobile phone through said call diverting unit.

22. The process as recited in claim 20, in step (c), further comprising the steps of:
(c-1) converting a dialing signal of said outgoing call from said domestic phone into said communication signal through said central processing unit; and
(c-2) sending said communication signal to said mobile phone through said call diverting unit.

23. The process, as recited in claim 18, further comprising a step of recharging said mobile phone when said mobile phone is electrically connected to said mobile phone bridging arrangement.

24. The process, as recited in claim 19, further comprising a step of recharging said mobile phone when said mobile phone is electrically connected to said mobile phone bridging arrangement.

25. The process, as recited in claim 22, further comprising a step of recharging said mobile phone when said mobile phone is electrically connected to said mobile phone bridging arrangement.

26. The process, as recited in claim 19, further comprising a step of inputting a preset parameter through said central processing unit to match said mobile phone with said corresponding domestic phone.

27. The process, as recited in claim 22, further comprising a step of inputting a preset parameter through said central processing unit to match said mobile phone with said corresponding domestic phone.

28. The process, as recited in claim 25, further comprising a step of inputting a preset parameter through said central processing unit to match said mobile phone with said corresponding domestic phone.
